(19) United States
(12) Patent Application Publication
(10) Pub. No.: US 2025/0047469 A1
(43) Pub. Date: Feb. 6, 2025

(54) REDUCED LATENCY METADATA ENCRYPTION AND DECRYPTION

(71) Applicant: Rambus Inc., San Jose, CA (US)

(72) Inventors: Evan Lawrence Erickson, Chapel Hill, NC (US); Michael Alexander Hamburg, ‘s-Hertogenbosch (NL); Taeksang Song, San Jose, CA (US); Wendy Elsasser, Austin, TX (US)

(21) Appl. No.: 18/669,731

(22) Filed: May 21, 2024

Related U.S. Application Data
(60) Provisional application No. 63/505,232, filed on May 31, 2023.

(51) Int. Cl. H04L 9/06; G06F 21/60

(52) U.S. Cl. CPC H04L 9/065; G06F 21/602

(57) ABSTRACT

Techniques for providing reduced latency metadata encryption and decryption are described herein. A memory buffer device having a cryptographic circuit to receive a first data and a first metadata associated with the first data. The cryptographic circuit can encrypt or decrypt the first metadata using a first cryptographic algorithm. The cryptographic circuit can encrypt or decrypt the first data using a second cryptographic algorithm. The first data and the first metadata can be stored at a same location, within a memory device, corresponding to a memory address.

### RELATED APPLICATIONS

This application claims the benefit of U.S. Provisional Patent Application No. 63/505,232, filed May 31, 2023, the entire contents of which are incorporated by reference.

### TECHNICAL FIELD

Aspects and embodiments of the disclosure relate generally to memory devices, and more specifically, to systems and methods for reduced latency metadata encryption and decryption.

### BACKGROUND

Modern computer systems generally include one or more memory devices, such as those on a memory module. The memory module may include, for example, one or more random access memory (RAM) devices or dynamic random access memory (DRAM) devices. A memory device can include memory banks made up of memory cells that a memory controller or memory client accesses through a command interface and a data interface within the memory device. The memory module can include one or more volatile memory devices. The memory module can be a persistent memory module with one or more non-volatile memory (NVM) devices.

### BRIEF DESCRIPTION OF THE DRAWINGS

The present disclosure is illustrated by way of example, and not by way of limitation, in the figures of the accompanying drawings.

FIG. 1 is a block diagram of a memory system with a memory module that includes a cryptographic circuit for reduced latency metadata encryption and decryption, according to at least one embodiment of the present disclosure.

FIG. 2 illustrates a cache line in which metadata associated with cache line data is stored side-band and a cache line in which metadata associated with cache line data is stored in-line, according to at least one embodiment of the present disclosure.

FIG. 3 is a process flow diagram of a method of cryptographically protecting data of a memory device by encrypting metadata associated with cache line data using a first cryptographic algorithm and encrypting the cache line data using a second cryptographic algorithm, according to at least one embodiment of the present disclosure.

FIG. 4 is a process flow diagram of a method of decrypting metadata associated with cache line data using a first cryptographic algorithm and decrypting the cache line data using a second cryptographic algorithm, according to at least one embodiment of the present disclosure.

FIG. 5 is a process flow diagram of a method of determining whether to decrypt cache line data based on an indicator within associated metadata, according to at least one embodiment of the present disclosure.

FIG. 6 is a flow diagram of a method for reduced latency metadata encryption and decryption, according to at least one embodiment of the present disclosure.

FIG. 7 is a block diagram of an integrated circuit with a memory controller, a cryptographic circuit, and a management processor, according to at least one embodiment of the present disclosure.

### DETAILED DESCRIPTION

The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format to avoid obscuring the present disclosure unnecessarily. Thus, the specific details set forth are merely exemplary. Particular implementations may vary from these exemplary details and still be contemplated to be within the scope of the present disclosure.

Datacenter architectures are evolving to support the workloads of emerging applications in Artificial Intelligence and Machine Learning that require a high-speed, low latency, cache-coherent interconnect. Compute Express Link® (CXL®) is an industry-supported cache-coherent interconnect for processors, memory expansion, and accelerators. The CXL® technology can utilize a security feature called Inline Memory Encryption (IME) for providing just-in-time encryption, decryption, and authentication for memory requests (e.g., read request and write requests) between a host and a memory. One IME algorithm is Advanced Encryption Standard (AES) XOR-Encrypt-XOR with Tweak and Block Ciphertext Stealing (XTS) (hereinafter AES-XTS). The AES-XTS algorithm uses a block cipher (e.g., AES-128, AES-256, etc.) for encryption and decryption. The AES-XTS algorithm can divide data into fixed-size blocks and encrypt each block separately using AES encryption with a tweakable block cipher. The tweak value can be determined from the block number and a key that is shared between encryption and decryption operations. It can be noted that other encryption and authentication algorithms can be used.

Storage and encryption of cache line metadata (also referred to as “metadata” herein) associated with cache line data is a desired capability for confidential computing, for example, encrypting data at rest in a memory device (e.g., DRAM). The metadata can contain, for example, coherency information for a Modified-Exclusive-Shared-Invalid (MESI) cache coherency protocol, TEE ownership tracking information, a message authentication code (MAC) for integrity checking, a poison bit, and/or the like. In some instances, the IME algorithm, AES-XTS, can be used to encrypt metadata. However, the CXL® protocol is highly sensitive to latency, and the IME algorithm, AES-XTS, can incur a latency penalty when it is used to encrypt metadata in addition to corresponding cache line data.

Hardware implementations of AES include an AES engine or AES cores that perform a series of transformations on input data to produce an output. In some instances, AES cores can take 14 cycles to decrypt encrypted cache line data and an additional 14 cycles to decrypt encrypted metadata, totaling 28 cycles. For example, four 128-bit AES cores of an AES engine can decrypt 512-bit cache line data on a first pass and can decrypt 16 bits of corresponding metadata on a second pass. On the first pass, the four 128-bit AES cores can decrypt the 512-bit cache line data, resulting in 14 cycles for the 512-bit output. Because the AES-XTS algorithm is a block cipher, the algorithm encrypts data in fixed-size block (e.g., 128 bits). Accordingly, the 16-bit metadata can be padded with 112 bits of data (e.g., the cache line data), resulting in 128-bit padded metadata. On a second pass, one of the four AES cores can decrypt the 128-bit padded metadata, resulting in an additional 14 cycles of latency for the 128-bit output, for a total latency penalty of 28 clock cycles.

Aspects and embodiments of the present disclosure address these deficiencies and other deficiencies by providing a cryptographic circuit that can have low latency (e.g., 1 additional clock cycle) for IME by encrypting/decrypting cache line data and associated metadata using different modes of AES. For example, the cryptographic circuit can use AES-XTS mode to perform cryptographic operations on cache line data and AES counter mode (AES-CTR) to perform cryptographic operations on associated metadata. AES-CTR is a stream cipher that generates a stream of bits called a keystream by encrypting a “number used only once” (NONCE) with the AES block cipher. Typically, the NONCE is a counter value that is incremented for each block of data that is encrypted, and the resulting keystream is XORed with an input (e.g., plaintext) to produce an output (e.g., ciphertext). During encryption, the cryptographic circuit disclosed herein can use a memory address corresponding to the cache line as the AES-CTR NONCE for computing the keystream. Because AES-CTR is a stream cipher, any length of metadata can be encrypted, as opposed to block ciphers like AES-XTS, which pad plaintext to be a multiple of the block size. For example, AES-CTR can encrypt 16 bits of metadata without padding the metadata to 128 bits. Additionally, because the AES-CTR is separate from AES-XTS, the cryptographic circuit can encrypt the cache line data and the associated metadata in parallel. Accordingly, the introduced technique improves the system's overall energy efficiency and latency, allowing the system to increase an overall frequency, thereby improving performance.

During a read operation, the cryptographic circuit can compute a metadata keystream in advance before it is needed and combine (e.g., XOR) the metadata keystream with the metadata as it arrives. In some embodiments, the cryptographic circuit can compute the metadata keystream using the memory address corresponding to the cache line as an AES-CTR NONCE. When the encrypted cache line data and corresponding encrypted metadata is read from memory (e.g., dynamic random-access memory (DRAM)), the cryptographic circuit can decrypt the encrypted cache line data in, for example, 14 clock cycles using AES-XTS. The cryptographic circuit can decrypt the encrypted metadata by XORing the encrypted metadata with the pre-computed keystream using AES-CTR in, for example, one clock cycle, for a total latency of 15 clock cycles.

Aspects and embodiments of the present disclosure can further send a pre-defined pattern cache line data to the host based on an indicator within the metadata to reduce latency associated with deferred memory allocation. In some embodiments, a memory (e.g., DRAM) can utilize a deferred memory allocation technique to delay allocation of memory until data in the memory is modified. For example, blocks (e.g., 2 megabytes (MB)) of memory (e.g., DRAM) can be queued and initialized with zeroes before the memory is allocated, and then allocated on demand when the host writes data or potentially non-zero data to the initialized zeroed memory. In some instances, the blocks of zeroed memory can be encrypted to achieve additional security. However, encrypting (and subsequently decrypting) blocks of zeroed memory can introduce substantial overhead. For example, different regions of memory may use different encryption/decryption keys, so, each region may be pre-zeroed and encrypted using a different key. This can result in a large number of keys (e.g., 2,000 keys) stored per memory module. To avoid overhead associated with deferred memory allocation, aspects and embodiments of the present disclosure can use a low-latency (e.g., 1 cycle) encryption method to obfuscate regions of pre-zeroed memory. A “zero flag” can be stored as metadata with each cache line to indicate whether the cache line data contains all zeroes. The cryptographic circuit can decrypt encrypted metadata by XORing the encrypted metadata with a pre-computed keystream prior to decrypting the associated cache line data, as described in above. Based on the value of the decrypted zero flag, the cryptographic circuit can return all zeroes or incur additional latency to decrypt and return the cache line data stored at the address in memory. Utilizing the zero flag to determine not to decrypt pre-zeroed memory can significantly reduce latency, memory overhead, and associated power consumption.

In some embodiments, the cryptographic circuit can be part of a device that supports the CXL® technology, such as a CXL® memory module. The CXL® memory module can include a CXL® controller or a CXL® memory expansion device (e.g., CXL® memory expander System on Chip (SoC)) that is coupled to DRAM (e.g., one or more volatile memory devices) and/or persistent storage memory (e.g., one or more NVM devices). The CXL® memory expansion device can include a management processor. The CXL® memory expansion device can include an error correction code (ECC) circuit to detect and correct errors in data read from memory or transferred between entities. The CXL® memory expansion device can use an IME circuit to encrypt the host's unencrypted data before storing it in the DRAM and to decrypt the encrypted data from the DRAM before returning it to the host. The IME circuit can perform aspects and implementations of the techniques described herein.

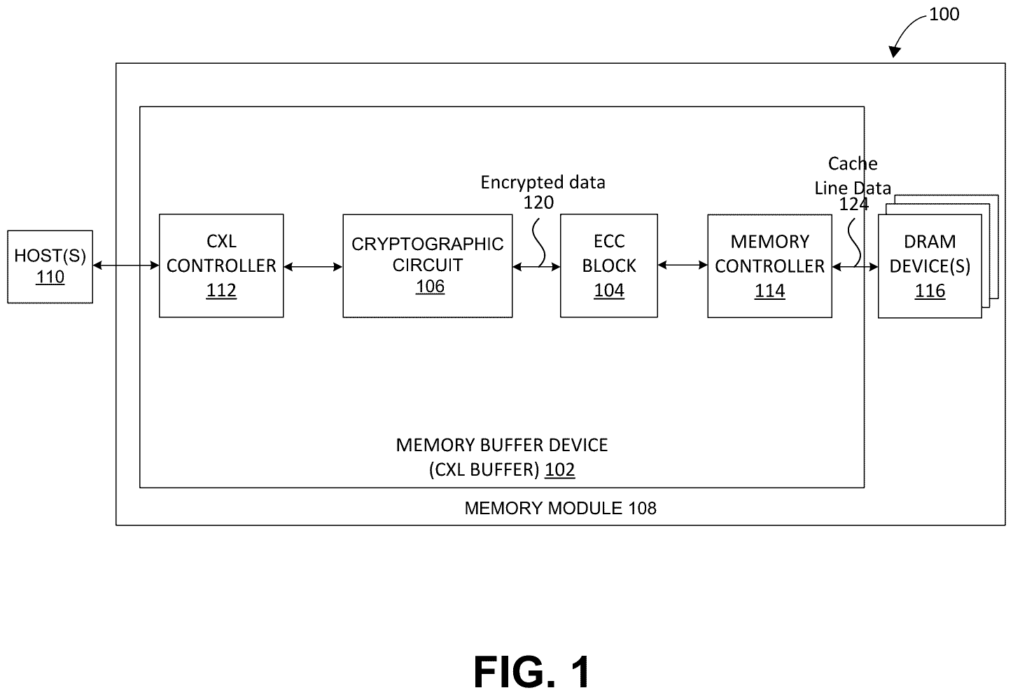

FIG. 1 is a block diagram of a memory system 100 with a memory module 108 that includes a cryptographic circuit 106 for reduced latency metadata encryption and decryption, according to at least one embodiment of the present disclosure. In one embodiment, the memory module 108 includes a memory buffer device 102 and one or more dynamic random-access memory (DRAM) device(s) 116. In one embodiment, the memory buffer device 102 is coupled to one or more DRAM device(s) 116 and a host(s) 110. In another embodiment, the memory buffer device 102 is coupled to a fabric manager that is operatively coupled to one or more hosts. In another embodiment, the memory buffer device 102 is coupled to host(s) 110 and the fabric manager. A fabric manager is software executed by a device, such as a network device or switch, that manages connections between multiple entities in a network fabric. The network fabric is a network topology in which components pass data to each other through interconnecting switches. A network fabric includes hubs, switches, adapter endpoints, etc., between devices.

In one embodiment, the memory buffer device 102 includes the cryptographic circuit 106. In at least one embodiment, memory buffer device 102 can receive data from host(s) 110 to be encrypted by the cryptographic circuit 106 before being stored in the DRAM devices(s) 116. In another embodiment, the cryptographic circuit 106 can receive encrypted data 120 from the DRAM device(s) 116. In some instances, encrypted data is stored in the DRAM device(s) 116 and retrieved by the memory buffer device 102 to be decrypted by the cryptographic circuit 106 before being transferred to the host(s) 110. In at least one embodiment, cryptographic circuit 106 is an inline memory encryption (IME) engine. In another embodiment, cryptographic circuit 106 is an encryption circuit or logic. In another embodiment, cryptographic circuit 106 is an AES engine or one or more AES cores to perform encryption and decryption operations described herein using AES algorithms.

In at least one embodiment, the cryptographic circuit 106 can generate a message authentication code (MAC) for each cache line to provide cryptographic integrity on accesses to the respective cache line or a set of cache lines of the encrypted data 120. In at least one embodiment, cryptographic circuit 106 can verify one or more MACs associated with the encrypted data stored in DRAM device(s) 116. The one or more MACs were previously generated. The cryptographic circuit 106 can decrypt the encrypted data to obtain decrypted data. In some embodiments, the MAC can be stored as metadata within the respective cache line.

In at least one embodiment, the memory buffer device 102 includes an ECC block 104 (e.g., ECC circuit) to detect and correct errors in cache lines or sets of cache lines being read from a DRAM device(s) 116. In at least one embodiment, ECC block 104 can generate and verify ECC information stored with each cache line or set of cache lines. The ECC block 104 can detect and correct an error in a cache line of the data using the ECC information. In some embodiments, metadata can be encoded within the ECC information. In some embodiments, the metadata can be stored within each cache line or set of cache lines in lieu of the ECC information. In such an embodiment, the ECC block 104 can be omitted from the memory buffer device 102.

In a further embodiment, the memory buffer device 102 includes a CXL® controller 112 and a memory controller 114. The CXL® controller 112 is coupled to host(s) 110 and the cryptographic circuit 106. The memory controller 114 is coupled to one or more DRAM device(s) 116. In a further embodiment, the memory buffer device 102 includes a management processor and a root of trust (not illustrated in FIG. 1). In at least one embodiment, the management processor can receive one or more management commands through a command interface between the host(s) 110 (or fabric manager) and the management processor. In at least one embodiment, the memory buffer device 102 is implemented in a memory expansion device, such as a CXL® memory expander SoC of a CXL® NVM module or a CXL® module. The memory buffer device 102 can encrypt unencrypted data (e.g., plain text or cleartext user data), received from a host(s) 110, using the cryptographic circuit 106 to obtain encrypted data 120 before storing the encrypted data 120 in the DRAM device(s) 116. The memory buffer device 102 can decrypt encrypted data (e.g., ciphertext) using the cryptographic circuit 106 to obtain decrypted data before sending the decrypted data to the host(s) 110.

The ECC block 104 can receive the encrypted data 120 from cryptographic circuit 106. The ECC block 104 can generate ECC information associated with the encrypted data 120. In some embodiments, the encrypted data 120, the MAC, and the ECC information can be organized as cache line data 124. In some embodiments, metadata associated with the cache line data 124 can contain information such as coherency information for a Modified-Exclusive-Shared-Invalid (MESI) cache coherency protocol, TEE ownership tracking information, the MAC, ECC information, a poison bit, a pattern flag (e.g., a zero flag), and/or the like. In some embodiments, the metadata can be encoded with the ECC information. The memory controller 114 can receive the cache line data 124 and the metadata from the ECC block 104 and store the cache line data 124 in the DRAM device(s) 116.

It should be noted that the memory buffer device 102 can receive unencrypted and encrypted data as it traverses a link (e.g., the CXL® link). This encryption is usually link encryption, referred to in CXL® as integrity and data encryption (IDE). The link encryption, in this case, would not persist to DRAM as the CXL® controller 112 in the memory module 108 can decrypt the link data and verify its integrity before the flow described herein where the cryptographic circuit 106 encrypts the data. Although “unencrypted data” is used herein, in other embodiments, the data can be encrypted data that is encrypted by the memory buffer device 102 using a key only used for the link, and thus cleartext data exists within the SoC after the CXL® controller 112 and thus needs to be encrypted by the cryptographic circuit 106 to provide encryption for data at rest.

In at least one embodiment, the CXL® controller 112 includes a host memory interface (e.g., CXL.mem) and a management interface (e.g., CXL.io). The host memory interface can receive from the host(s) 110, one or more memory access commands of a remote memory protocol, such as the CXL® protocol, Gen-Z, Open Memory Interface (OMI), Open Coherent Accelerator Processor Interface (OpenCAPI), or the like. The management interface can receive one or more management commands of the remote memory protocol from the host(s) 110 or the fabric manager by way of the management processor.

In at least one embodiment, cryptographic circuit 106 receives a data stream from a host(s) 110 and encrypts the data stream into the encrypted data 120, and provides the encrypted data 120 to the ECC block 104 and the memory controller 114. Memory controller 114 stores the encrypted data 120 in the DRAM device(s) 116 along with the metadata. In some embodiments, the encrypted data 120 and the metadata can be accessed as individual cache lines.

In some embodiments, the memory module 108 has persistent memory backup capabilities where the management processor can access the encrypted data 120 and transfer the encrypted data from the DRAM device(s) 116 to persistent memory (not illustrated in FIG. 1) in the event of a power-down event or a power-loss event. The encrypted data 120 in the persistent memory is considered data at rest. In at least one embodiment, the management processor transfers the encrypted data to the persistent memory using an NVM controller (e.g., NAND controller).

The cryptographic circuit 106 can include multiple cryptographic algorithms, such as a first cryptographic algorithm (e.g., AES-CTR) and a second cryptographic algorithm (e.g., AES-XTS). In other embodiments, cryptographic algorithms can also provide cryptographic integrity, such as using a MAC. In other embodiments, cryptographic integrity can be provided separately from encryption/decryption. In some cases, the strength of the MAC and cryptographic algorithms can differ. In at least one embodiment, the cryptographic circuit 106 is an IME engine with two cryptographic algorithms. In another embodiment, the cryptographic circuit 106 includes two separate IME engines, each having one of the two cryptographic algorithms. In another embodiment, the cryptographic circuit 106 includes a first cryptographic circuit for the first cryptographic algorithm and a second cryptographic circuit for the second cryptographic algorithm. Alternatively, additional cryptographic algorithms can be implemented in the cryptographic circuit 106. The memory controller 114 can receive the encrypted data 120 from the cryptographic circuit 106 and store the encrypted data 120 in one or more of the DRAM device(s) 116.

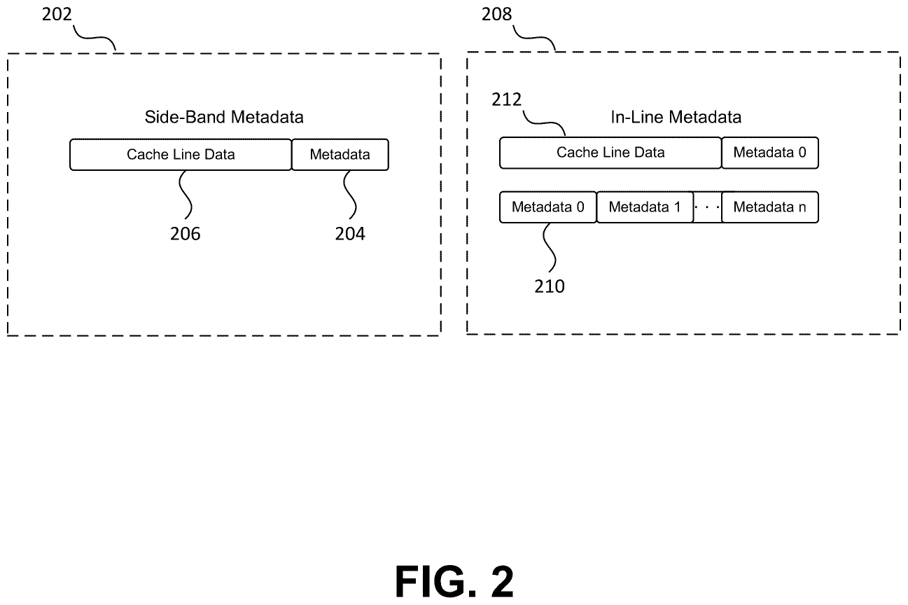

In at least one embodiment, metadata can be stored and transferred in connection with cache line data 124. The metadata can be stored and transferred in side-band metadata or in-line metadata, as illustrated and described below with respect to FIG. 2. In at least one embodiment, the cryptographic circuit 106 can encrypt/decrypt the metadata using the first cryptographic algorithm (e.g., AES-CTR) and encrypt/decrypt the cache line data 124 using the second cryptographic algorithm (e.g., AES-XTS). During a read operation, the cryptographic circuit 106 can pre-compute a metadata keystream using a memory address corresponding to the cache line as an AES-CTR NONCE as the cache line is being read from the DRAM device(s) 116. Accordingly, the cryptographic circuit 106 can combine (e.g., XOR) the metadata keystream with metadata as it arrives from the DRAM device(s) 116, resulting in reduced latency (e.g., 1 cycle instead of 14 cycles) metadata decryption. During a write operation, the cryptographic circuit 106 can encrypt the metadata and cache line data in parallel as it is received from the host(s) 110 over the CXL link.

FIG. 2 illustrates a cache line 202 in which metadata 204 associated with cache line data 206 is stored side-band and a cache line 208 in which metadata 210 associated with cache line data 212 is stored in-line, according to at least one embodiment of the present disclosure. In general, the metadata can include one or more ECC symbols, a MAC, TEE ownership tracking information, a poison bit, a pattern flag (e.g., a zero flag), and/or other information generated by the host or the memory module. The metadata can be stored as side-band metadata 204 or in-line metadata 210. The side-band metadata 204 can be accessible when the cache line 202 is read from memory. The in-line metadata 210 can be stored in another location than the cache line data 212, such as in a static RAM (SRAM) or another cache line in DRAM. When the cache line 208 is read, an additional memory read can be performed to retrieve the in-line metadata 210.

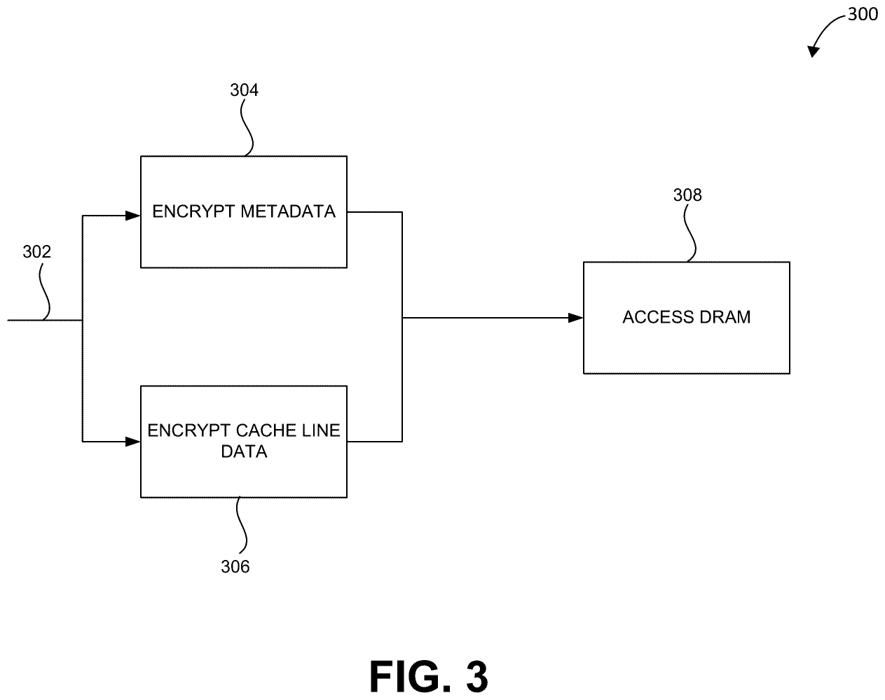

FIG. 3 is a process flow diagram of a method 300 of cryptographically protecting data of a memory device by encrypting metadata associated with cache line data using a first cryptographic algorithm and encrypting the cache line data using a second cryptographic algorithm, according to at least one embodiment of the present disclosure. The method 300 can be performed by processing logic that can include hardware (e.g., circuitry, dedicated logic, programmable logic, microcode, etc.), software (e.g., instructions run on a processing device to perform hardware simulation), firmware, or any combination thereof. In one embodiment, the method 300 can be performed by the memory buffer device 102 of FIG. 1, a memory expansion device, a memory module 108 of FIG. 1, and/or an integrated circuit including a cryptographic circuit 106 of FIG. 1. In some embodiments, the method 300 can be performed by an Advanced Encryption Standard (AES) engine including hardware and/or software components to perform encryption and decryption operations described herein using one or more AES algorithms. The AES engine can include one or more AES cores to perform the method 300.

The method 300 begins when processing logic, operatively coupled to one or more hosts, such as host(s) 110 of FIG. 1, receives a request 302 from the host to write data, such as cache line data 206 of FIG. 2, and associated metadata, such as metadata 204 of FIG. 2, to a memory device, such as DRAM device(s) 116 of FIG. 1. The request can further include a memory address corresponding to a cache line, such as cache line 202, within the DRAM device in which the cache line data and metadata are to be stored.

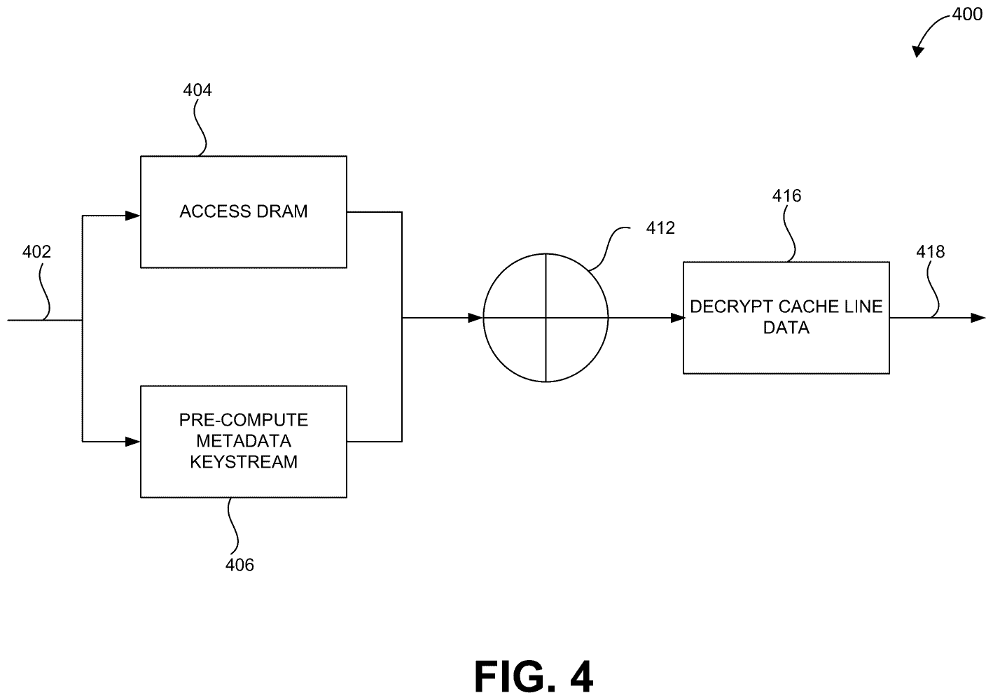

At block 304, the processing logic can encrypt the metadata using a first cryptographic algorithm. In some embodiments, the cryptographic algorithm can be a stream cipher such as AES-CTR stream cipher, Salsa20 stream cipher, Rivest Cipher (RC4), ChaCha stream cipher, and/or other stream ciphers. In an illustrative example, the processing logic can encrypt the metadata using AES-CTR. To encrypt the metadata using AES-CTR, the processing logic can generate a random or pseudo-random metadata encryption key (e.g., a 128-bit key, a 192-bit key, a 256-bit key, etc.). The processing logic can compute a metadata keystream using the memory address of the cache line as an AES-CTR NONCE and the metadata encryption key. The processing logic can apply an encryption function (e.g., AES) to the AES-CTR NONCE using the metadata encryption key to compute the metadata keystream. The processing logic can combine (e.g., XOR) the metadata with the metadata keystream to obtain encrypted metadata. The metadata encryption key can be stored in a dedicated hardware device (e.g., a hardware security module (HSM)) and/or software for later retrieval to decrypt the encrypted metadata, as described below with respect to FIG. 4. In some embodiments, the metadata encryption key can be used for one or more blocks of metadata. For example, the metadata encryption key can be unique to a region of memory and can be used to encrypt/decrypt metadata corresponding to that region of memory. It is appreciated that the metadata encryption key can be a global key, a per-region key, a per-host key, a per-VM key, etc.

At block 306, the processing logic can encrypt the cache line data using a second cryptographic algorithm. In some embodiments, the cryptographic algorithm can be a block cipher such as AES-XTS block cipher, DES block cipher, IDEA block cipher, Serpent block cipher, Twofish block cipher, and/or other block ciphers. In an illustrative example, the processing logic can encrypt the cache line data using AES-XTS (with a block size of 128 bits, 192 bits, 256 bits, etc.). The AES-XTS algorithm can divide the cache line data into fixed-size blocks (e.g., 128 bit blocks) and encrypt each block separately using AES encryption with a tweakable block cipher to obtain encrypted cache line data. The tweak value can be determined from a respective block number and an encryption key that is shared between encryption and decryption operations. The encryption key can be stored in a dedicated hardware device (e.g., a hardware security module (HSM)) and/or software for later retrieval to decrypt the encrypted cache line data, as described below with respect to FIG. 4. It is appreciated that the encryption key can be a global key, a per-region key, a per-host key, a per-VM key, etc. In some embodiments, the encryption key used at block 306 for encrypting the cache line data and the metadata encryption key used at block 304 for encrypting the metadata can be different keys. In some embodiments, the encryption key and metadata encryption key can be the same key. In some embodiments, the processing logic can perform the operations of block 304 and block 306 is parallel such that the metadata can be encrypted in addition to the cache line data without adding additional latency.

At block 308, the processing logic can access DRAM to store the encrypted cache line data and the encrypted metadata at a cache line associated with the memory address (e.g., a write operation). In some embodiments, the cache line can correspond to cache line 202 of FIG. 2, and the cache line data and the metadata can be stored side-band. In some embodiments, the cache line can correspond to cache line 208, and the cache line data and the metadata can be stored in-line.

FIG. 4 is a process flow diagram of a method 400 of decrypting metadata associated with cache line data using a first cryptographic algorithm and decrypting the cache line data using a second cryptographic algorithm, according to at least one embodiment of the present disclosure. The method 400 can be performed by processing logic that can include hardware (e.g., circuitry, dedicated logic, programmable logic, microcode, etc.), software (e.g., instructions run on a processing device to perform hardware simulation), firmware, or a combination thereof. In one embodiment, the method 400 can be performed by the memory buffer device 102 of FIG. 1, a memory expansion device, a memory module 108 of FIG. 1, or an integrated circuit including cryptographic circuit 106 of FIG. 1. In some embodiments, the method 400 can be performed by an Advanced Encryption Standard (AES) engine including hardware and/or software components to perform encryption and decryption operations described herein using one or more AES algorithms. The AES engine can include one or more AES cores to perform the method 400.

The method 400 begins by processing logic, operatively coupled to a host, such as host(s) 110 of FIG. 1, receiving a request 402 from the host to read data and associated metadata from a memory device, such as DRAM device(s) 116 of FIG. 1. The data, for example, can correspond to cache line data 206 of FIG. 2 and the metadata can correspond to metadata 204 of FIG. 2 stored side-band with the cache line data. The request can include a memory address corresponding to a cache line, such as cache line 202, within the DRAM device in which the cache line data and metadata is stored. At block 404, the processing logic can access the DRAM device to retrieve the cache line data and the metadata stored at the memory address (e.g., a read operation). During the DRAM access and at block 406, the processing logic can pre-compute a metadata keystream to decrypt the encrypted metadata using a stream cipher as the encrypted metadata arrives from the DRAM device. The stream cipher can include an AES-CTR stream cipher, Salsa20 stream cipher, Rivest Cipher (RC4), ChaCha stream cipher, and/or other stream ciphers. In some embodiments, the processing logic can use the memory address of the cache line to compute the metadata keystream for the stream cipher.

In an illustrative example, the stream cipher can be AES-CTR, and the processing logic can compute the metadata keystream using the memory address of the cache line as an AES-CTR NONCE. To compute the metadata keystream, the processing logic can utilize a metadata encryption key. The metadata encryption key can be stored, for example, in a secure hardware environment, such as a hardware security module (HSM) or other secure storage device that provides tamper-resistant protection for the metadata encryption key. It is appreciated that the metadata encryption key can be a global key, a per-region key, a per-host key, etc. The processing logic can encrypt the cache line memory address (i.e., the AES-CTR NONCE) using the AES algorithm to produce the metadata keystream. The processing logic can perform an exclusive or (XOR) operation 412 on the metadata keystream and the metadata to decrypt the metadata as it arrives from DRAM. It can be noted that the DRAM access of block 404 and the metadata keystream computation of block 406 can be performed in parallel. Accordingly, decrypting the metadata can include latency associated with the XOR operation 412, which can result in little additional latency (e.g., one clock cycle of additional latency).

At block 416, the processing logic can decrypt the cache line data. In some embodiments, the processing logic can decrypt the cache line data using a block cipher such as AES-XTS block cipher, DES block cipher, IDEA block cipher, Serpent block cipher, Twofish block cipher, and/or other block ciphers. In an illustrative example, the processing logic can decrypt the cache line data using AES-XTS (with a block size of 128 bits, 192 bits, 256 bits, etc.). The AES-XTS block cipher can divide the cache line data into fixed-size blocks (e.g., 128 bit blocks) and decrypt each block separately using AES decryption with a tweakable block cipher to obtain decrypted cache line data. The tweak value can be determined from a respective block number and an encryption key that is shared between encryption and decryption operations, as described above. The encryption key can be retrieved from a dedicated hardware device (e.g., a hardware security module (HSM)) and/or software.

The processing logic can further issue a response 418 to the host including the decrypted cache line data and decrypted metadata.

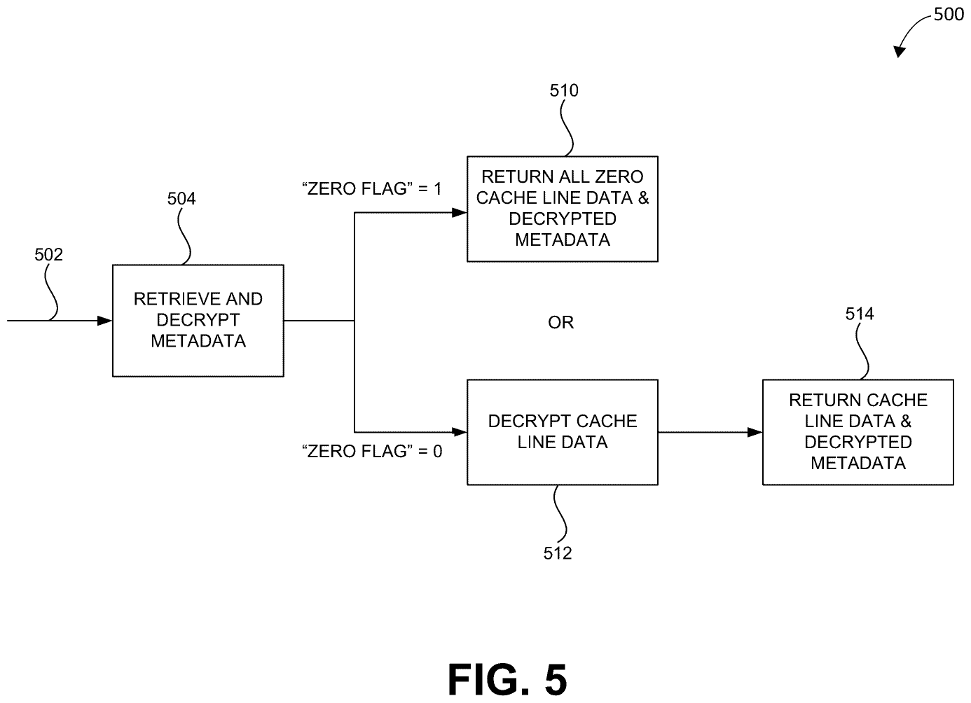

FIG. 5 is a process flow diagram of a method of determining whether to decrypt cache line data based on an indicator within associated metadata, according to at least one embodiment of the present disclosure. The method 500 can be performed by processing logic that can include hardware (e.g., circuitry, dedicated logic, programmable logic, microcode, etc.), software (e.g., instructions run on a processing device to perform hardware simulation), or a combination thereof. In one embodiment, the method 500 can be performed by the memory buffer device 102 of FIG. 1, a memory expansion device, a memory module 108 of FIG. 1, and an integrated circuit including cryptographic circuit 106 of FIG. 1. In some embodiments, the method 500 can be performed by an Advanced Encryption Standard (AES) engine including hardware and/or software components to perform encryption and decryption operations described herein using one or more AES algorithms. The AES engine can include one or more AES cores to perform the method 500.

In some embodiments, a memory device, such as DRAM devices(s) 116 of FIG. 1, can utilize a deferred memory allocation technique to delay allocation of memory until the memory is needed. For example, blocks (e.g., 2 megabytes (MB)) of memory can be queued and initialized with zeroes before the memory is needed and then allocated on demand when the memory is needed. In some instances, the blocks of zeroed memory can be encrypted to achieve additional security. However, encrypting (and subsequently decrypting) blocks of zeroed memory can introduce substantial overhead. For example, different regions of memory may use different keys, so, each region may be pre-zeroed and encrypted using a different key. This can result in a large number of keys (e.g., 2,000 keys) stored per memory module. To avoid overhead associated with deferred memory allocation, a cryptographic circuit, such as cryptographic circuit 106 of FIG. 1, can use a low-latency (e.g., 1 cycle) and/or low-power encryption method to obfuscate regions of pre-zeroed memory instead of a standard encryption method (e.g., AES-XTS-256). For example, the cryptographic circuit 106 can obfuscate the regions of pre-zeroed memory using AES-CTR, ChaCha20, a low-latency hash function such as a Cyclic Redundancy Check (CRC) hash function, or the like. A “zero flag” can be stored as metadata with each cache line to indicate whether the cache line data contains all zeroes. The method 500 determines whether to decrypt the cache line data based on the value of the zero flag stored within the associated metadata. It is appreciated that operations described with respect to regions of pre-zeroed memory can be applied to any pre-defined pattern of data, and a corresponding pattern flag can be stored as metadata to indicate whether to decrypt the cache line data based on the value of pattern flag. For example, the pre-defined pattern of data can be a pattern of alternating ones and zeroes and the pattern flag can be stored within associated metadata to indicate whether the underlying cache line data is the pre-defined pattern of alternating ones and zeroes.

The method 500 begins when processing logic, operatively coupled to one or more hosts, such as host(s) 110 of FIG. 1, receives a request 502 from the host to read data and associated metadata from a memory device, such as DRAM device(s) 116 of FIG. 1. The data, for example, can correspond to cache line data 206 of FIG. 2 and the metadata can correspond to metadata 204 of FIG. 2, stored side-band with the cache line data. The request can include a memory address corresponding to a cache line, such as cache line 202 of FIG. 2, within the DRAM device in which the encrypted cache line data and corresponding encrypted metadata are stored. At block 504, the processing logic can retrieve and decrypt the encrypted metadata. The processing logic can access the DRAM device to retrieve the metadata stored at the memory address (e.g., a read operation). In some embodiments, the processing logic can decrypt the encrypted metadata using a stream cipher such as an AES-CTR stream cipher, Salsa20 stream cipher, Rivest Cipher (RC4), ChaCha stream cipher, and/or other stream ciphers.

For example, the processing logic can decrypt the encrypted metadata using AES-CTR mode by combining (e.g., XORing) the encrypted metadata with a computed keystream prior to decrypting associated cache line data to obtained decrypted metadata, as described in above with respect to FIG. 4. A portion of the decrypted metadata can include a zero flag to indicate whether plaintext associated with the encrypted cache line is all zeroes. The zero flag can be a single bit (e.g., the least-significant bit) of the decrypted metadata. Responsive to a determination that the zero flag is asserted (i.e., the zero flag equals one), the method 500 continues to block 510. Responsive to a determination that the zero flag is negated (i.e., the zero flag equals zero), the method 500 continues to block 512.

At block 510, the processing logic returns, to the host, a block of zeroes and, optionally, some of or all of the decrypted metadata. Because the decrypted metadata indicates the cache line data, the processing logic can return the contents of the cache line data (e.g., the block of zeroes) without decrypting the cache line data. It is appreciated that the processing logic can return a pre-defined pattern of data other than a block of zeroes responsive to a determination that a corresponding flag within the metadata is asserted. For example, the processing logic can return a block of ones, or any other pattern of data.

At block 512, the processing logic decrypts the cache line data. In some embodiments, the processing logic can decrypt the cache line data using a block cipher such as the AES-XTS block cipher, as described above with respect to FIG. 4. At block 514, the processing logic returns the cache line data and, optionally, some or all of the decrypted metadata to the host.

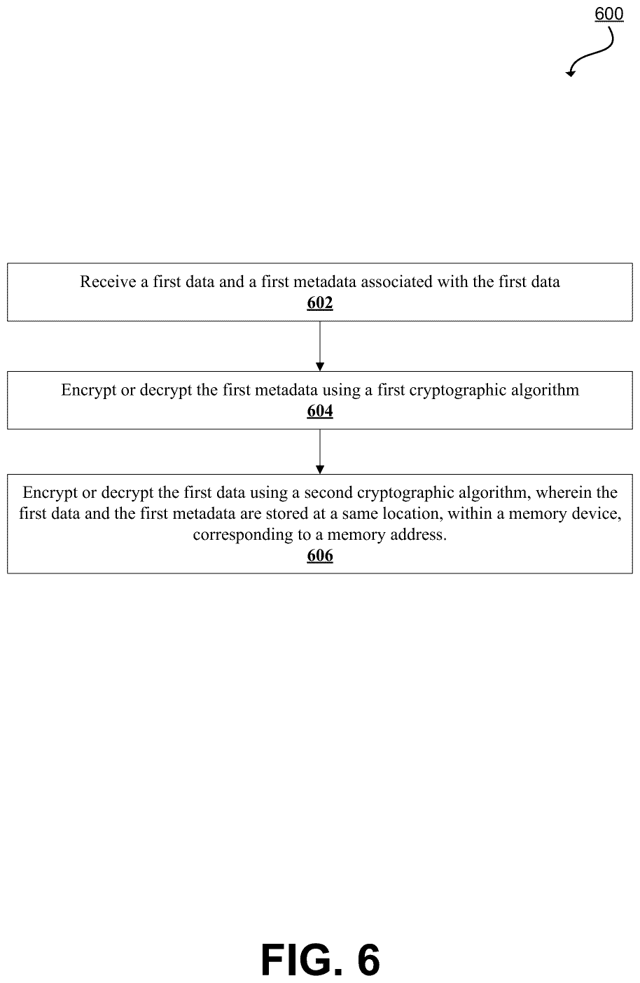

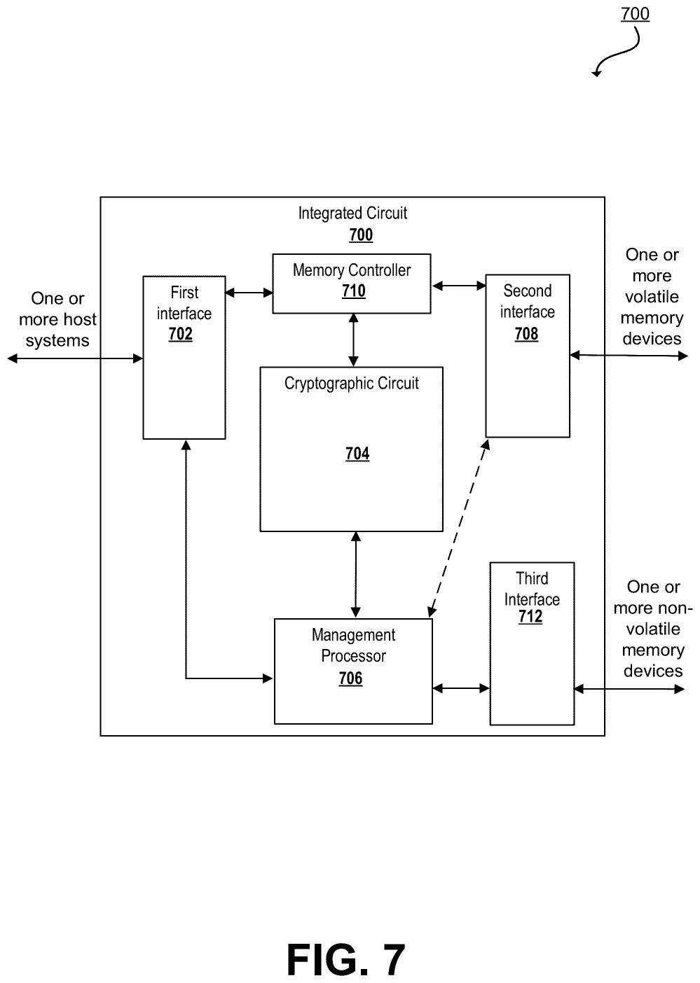

FIG. 6 is a flow diagram of a method 600 for reduced latency metadata encryption and decryption, according to at least one embodiment of the present disclosure. The method 600 may be performed by processing logic that can include hardware (e.g., circuitry, dedicated logic, programmable logic, microcode, etc.), software (e.g., instructions run on a processing device to perform hardware simulation), firmware, or any combination thereof. In one embodiment, the method 600 can be performed by the memory buffer device 102 of FIG. 1. In another embodiment, the method 600 can be performed by a memory expansion device. In another embodiment, the method 600 can be performed by the memory module 108 of FIG. 1. In another embodiment, the method 600 can be performed by an integrated circuit 700 of FIG. 7, having a cryptographic circuit 704. Alternatively, other devices can perform the method 600. Although shown in a particular sequence or order, unless otherwise specified, the order of the operations can be modified. Thus, the illustrated embodiments should be understood only as examples, and the illustrated operations can be performed in a different order, and some operations can be performed in parallel. Additionally, one or more operations can be omitted in various embodiments. Thus, not all operations are required in every embodiment.

The method 600 begins at block 602. At block 602, the processing logic receives a first data and a first metadata associated with the first data. In some embodiments, a portion of the first data includes one or more error correcting code (ECC) symbols, and the first metadata are encoded within the one or more ECC symbols.

At block 604, the processing logic encrypts or decrypts the first metadata using a first cryptographic algorithm. In some embodiments, the first cryptographic algorithm is a stream cipher. For example, the first cryptographic algorithm can be AES-CTR, as described above with respect to FIG. 3 and FIG. 4.

At block 606, the processing logic encrypts or decrypts the first data using a second cryptographic algorithm. The first data and the first metadata are stored at a same location, within a memory device, such as DRAM device(s) 116 of FIG. 1, corresponding to a memory address. For example, the first data first metadata can be stored in a cache line, such as cache line 202 of FIG. 2, of DRAM device(s) 116. In some embodiments, the first cryptographic algorithm is a block cipher. For example, the second cryptographic algorithm can be AES-XTS, as described above with respect to FIG. 3 and FIG. 4.

In some embodiments the processing logic further receives, from a host, such as host(s) 110 of FIG. 1, a request to read data from the memory device. The processing logic can pre-compute a keystream associated with the first memory address corresponding to using a memory address corresponding to the cache line. The processing device can read the first metadata and first data from the memory device and decrypt the first metadata using the keystream to obtain a decrypted first metadata. The processing device can decrypt the first data using the second cryptographic algorithm to obtain a decrypted first data and send the decrypted first data to the host. It is appreciated that the host is used by way of example, and not limitation, noting that another type of entity can request the memory device to perform memory operations (e.g., reads, writes, etc.) and receive responses to requests. For example, the entity may be referred to generally as initiator that initiates memory operations at a target (e.g., the memory device).

In some embodiments, the processing logic can further determine whether to decrypt a second data based on an indicator within a second metadata. In some embodiments, responsive to a determination not to decrypt the second data, the processing logic is further to send a third data to the host. In some embodiments, the third data is a pre-defined pattern of data, such as all zero cache line data described above with respect to FIG. 5.

In some embodiments, the processing logic further receives, from the host, a request to write the first data to the memory device. The processing logic can further encrypt the first data and the first metadata in parallel to obtain an encrypted first data and an encrypted first metadata and write the encrypted first data and the encrypted first metadata to the memory device.

In some embodiments, the processing logic receives, from the host, a request to write a second data to the memory device, where the second data is a pre-defined pattern of data. The processing logic can obfuscate the second data using a third cryptographic algorithm to obtain obfuscated data and assert an indicator within a second metadata associated with the second data to indicate that the second data is the pre-defined pattern of data. The processing logic can write the obfuscated data to the memory device.

FIG. 7 is a block diagram of an integrated circuit 700 with a memory controller 710, a cryptographic circuit 704, and a management processor 706 according to at least one embodiment of the present disclosure. In at least one embodiment, the integrated circuit 700 is a controller device that can communicate with one or more host systems (not illustrated in FIG. 7) using a cache-coherent interconnect protocol (e.g., the CXL) protocol). The integrated circuit 700 can be a device that implements the CXL™ standard. The CXL™ protocol can be built upon physical and electrical interfaces of a PCI Express® standard with protocols that establish coherency, simplify the software stack, and maintain compatibility with existing standards. The integrated circuit 700 includes a first interface 702 coupled to the one or more host systems or a fabric manager, a second interface 708 coupled to one or more volatile memory devices (not illustrated in FIG. 7), and an optional third interface 712 coupled to one or more non-volatile memory devices (not illustrated in FIG. 7). The one or more volatile memory devices can be DRAM devices. The integrated circuit 700 can be part of a single-host memory expansion integrated circuit, a multi-host memory pooling integrated circuit coupled to multiple host systems over multiple cache-coherent interconnects, or the like.

In one embodiment, the memory controller 710 receives data from one or more host systems over the first interface 702 or a volatile memory device over the second interface 708. The memory controller 710 can send the data or a copy of the data to the cryptographic circuit 704. The cryptographic circuit 704 can include cryptographic circuitry, cryptographic logic, an IME block, an IME engine, IME logic, or a cryptographic block to encrypt and/or decrypt data (e.g., cache line data) and associated metadata. The cryptographic circuit 704 can encrypt/decrypt cache line data using a first cryptographic algorithm (e.g., AES-XTS) and encrypt/decrypt the metadata using a second cryptographic algorithm (e.g., AES-CTR). In at least one embodiment, the integrated circuit 700 can include an ECC block or circuit. The ECC block can generate ECC information at different sizes.

In another embodiment, the integrated circuit 700 can include a cryptographic circuit that can encrypt/decrypt data being stored in the one or more volatile memory devices coupled to the management processor 706 via a second interface 708, or one or more non-volatile memory devices coupled to the management processor 706 via a third interface 712.

In another embodiment, the one or more non-volatile memory devices are coupled to a second memory controller (not illustrated) of the integrated circuit 700. In another embodiment, the integrated circuit 700 is a processor that implements the CXL® standard and includes the cryptographic circuit 704 and memory controller 710. In another embodiment, the integrated circuit 700 can include more or fewer interfaces than three.

It is to be understood that the above description is intended to be illustrative and not restrictive. Many other implementations will be apparent to those of skill in the art upon reading and understanding the above description. Therefore, the disclosure scope should be determined with reference to the appended claims, along with the full scope of equivalents to which such claims are entitled.

In the above description, numerous details are set forth. It will be apparent, however, to one skilled in the art that the aspects of the present disclosure may be practiced without these specific details. In some instances, well-known structures and devices are shown in block diagram form rather than in detail to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

However, it should be borne in mind that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “setting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer-readable storage medium, such as, but not limited to, any type of disk, including floppy disks, optical disks, CD-ROMs, magnetic-optical disks, read-only memories (ROMs), random-access memories (RAMs), erasable programmable ROMs (EPROMs), electrically erasable programmable ROMs (EEPROMs), magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct more specialized apparatuses to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any procedure for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

What is claimed is:

1. A memory buffer device comprising:
a cryptographic circuit to receive a first data and a first metadata associated with the first data, wherein the cryptographic circuit is further to:
encrypt or decrypt the first metadata using a first cryptographic algorithm; and
encrypt or decrypt the first data using a second cryptographic algorithm, wherein the first data and the first metadata are stored at a same location, within a memory device, corresponding to a memory address.

2. The memory buffer device of claim 1, wherein the first cryptographic algorithm is a stream cipher, and the second cryptographic algorithm is a block cipher.

3. The memory buffer device of claim 1, wherein the cryptographic circuit is further to:
receive, from a host, a request to read the first data from a memory device;
pre-compute a keystream associated with the first metadata using the memory address;
read the first metadata and the first data from the memory device;
decrypt the first metadata using the keystream to obtain a decrypted first metadata;
decrypt the first data using the second cryptographic algorithm to obtain a decrypted first data; and
send the decrypted first data to the host.

4. The memory buffer device of claim 1, wherein the cryptographic circuit is further to determine whether to decrypt a second data based on an indicator within a second metadata.

5. The memory buffer device of claim 4, wherein the cryptographic circuit, responsive to a determination not to decrypt the second data, is further to send a third data to a host, wherein the third data is a pre-defined pattern of data.

6. The memory buffer device of claim 1, wherein the cryptographic circuit is further to:
receive, from a host, a request to write the first data to a memory device;
encrypt the first data and the first metadata in parallel to obtain an encrypted first data and an encrypted first metadata; and
write the encrypted first data and the encrypted first metadata to the memory device.

7. The memory buffer device of claim 1, wherein the cryptographic circuit is further to:
receive, from a host, a request to write a second data to a memory device, wherein the second data is a pre-defined pattern of data;
obfuscate the second data using a third cryptographic algorithm to obtain obfuscated data;
assert an indicator within a second metadata associated with the second data to indicate that the second data is the pre-defined pattern of data; and
write the obfuscated data to the memory device.

8. The memory buffer device of claim 1, wherein a portion of the first data comprises one or more error correcting code (ECC) symbols and the first metadata are encoded within the one or more ECC symbols.

9. A cryptographic circuit to receive a first data and a first metadata associated with the first data, wherein the cryptographic circuit is further to:
encrypt or decrypt the first metadata using a first cryptographic algorithm; and
encrypt or decrypt the first data using a second cryptographic algorithm, wherein the first data and the first metadata are stored at a same location, within a memory device, corresponding to a memory address.

10. The cryptographic circuit of claim 9, wherein the first cryptographic algorithm is a stream cipher, and the second cryptographic algorithm is a block cipher.

11. The cryptographic circuit of claim 9, wherein the cryptographic circuit is further to:
receive, from a host, a request to read the first data from the memory device;
pre-compute a keystream associated with the first metadata using the memory address;
read the first metadata and the first data from the memory device;
decrypt the first metadata using the keystream to obtain a decrypted first metadata;
decrypt the first data using the second cryptographic algorithm to obtain a decrypted first data; and
send the decrypted first data to the host.

12. The cryptographic circuit of claim 9, wherein the cryptographic circuit is further to determine whether to decrypt a second data based on an indicator within a second metadata.

13. The cryptographic circuit of claim 12, wherein the cryptographic circuit, responsive to a determination not to decrypt the second data, is further to send a third data to a host, wherein the third data is a pre-defined pattern of data.

14. The cryptographic circuit of claim 9, wherein the cryptographic circuit is further to:
receive, from a host, a request to write the first data to the memory device;
encrypt the first data and the first metadata in parallel to obtain an encrypted first data and an encrypted first metadata; and
write the encrypted first data and the encrypted first metadata to the memory device.

15. The cryptographic circuit of claim 9, wherein the cryptographic circuit is further to:
receive, from a host, a request to write a second data to the memory device, wherein the second data is a pre-defined pattern of data;
obfuscate the second data using a third cryptographic algorithm to obtain obfuscated data;
assert an indicator within a second metadata associated with the second data to indicate that the second data is the pre-defined pattern of data; and
write the obfuscated data to the memory device.

16. The cryptographic circuit of claim 9, wherein a portion of the first data comprises one or more error correcting code (ECC) symbols and the first metadata are encoded within the one or more ECC symbols.

17. A method of cryptographically protecting data of a memory device, the method comprising:
receiving the data and metadata associated with the data;
encrypting or decrypting the metadata using a first cryptographic algorithm; and
encrypting or decrypting the data using a second cryptographic algorithm, wherein the data and the metadata are stored at a same location, within the memory device, corresponding to a memory address.

18. The method of claim 17, wherein the first cryptographic algorithm is a stream cipher, and the second cryptographic algorithm is a block cipher.

19. The method of claim 17, further comprising:
receiving, from a host, a request to read the data from the memory device;
pre-computing a keystream associated with the metadata using the memory address;
reading the metadata and the data from the memory device;
decrypting the metadata using the keystream to obtain decrypted metadata;
decrypting the data using the second cryptographic algorithm to obtain decrypted data; and
sending the decrypted data to the host.

20. The method of claim 17, further comprising:
receiving, from a host, a request to write the data to the memory device;
encrypting the data and the metadata in parallel to obtain encrypted data and encrypted metadata; and
writing the encrypted data and the encrypted metadata to the memory device.
